(19) United States
(12) Patent Application Publication
(10) Pub. No.: US 2005/0012828 A1
(43) Pub. Date: Jan. 20, 2005

(54) Digital camera, method for controlling digital camera, computer program for controlling a digital camera, signal for controlling digital camera and image playback apparatus

(75) Inventor: Koji Oka, Machida (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ricoh Company, Ltd., Yokohama-shi (JP)

(21) Appl. No.: 10/892,307

(22) Filed: Jul. 16, 2004

(30) Foreign Application Priority Data
Jul. 18, 2003 (JP) 2003-199197

(51) Int. Cl. H04N 5/76

(52) U.S. Cl. 348/231.2; 348/207.1

(57) ABSTRACT

A digital camera having a temporary memory for driving a display. The temporary memory is fed image data from an external or internal non-volatile memory. The temporary memory is controlled so that it stores the image on display along with a predetermined number of previously viewed and to-be-viewed images. In response to a frame advance command, one image is deleted from temporary memory and another image is added to the temporary memory. The digital camera is configured to temporarily interrupt image uploading when the operator exercises a command, such as a frame advance command.

### BACKGROUND OF THE INVENTION

1. Field of the Invention

The present invention relates to a digital camera, and a corresponding method and computer program product, with an improved memory management capability.

2. Description of the Related Art

Conventionally, digital cameras display images that are stored in a permanent memory, where the permanent memory is either external to the camera, permanently installed in the camera, or removable from the camera.

Japanese Patent Laid-Open No. 9-153129 discloses an image library system that stores images that are shot by a digital still camera, and transmits the stored image in the image playback device in response to an instruction from the image playback device.

But the prior art camera described in a Japanese Patent Laid-Open No. 9-153129 cannot operate both of the image pickup unit and the image playback device separately. That is, when the images are being transferred to the image library, the camera is prevented from taking more pictures. Thus, the prior art camera is not capable of rapid shooting in that it can not shoot a next picture until transmission of a previous image data is complete. Also, the prior art camera cannot receive an image from the image playback device. Furthermore, the prior art camera takes a long time for shooting and playback when many image files are handled.

Japanese Patent Laid-Open No. 2001-359044 gazette discloses technologies that can display an image stored in an external hard disk drive on a LCD display panel of a digital camera. A computer having the hard disk drive is connected to the camera thru a communication cable. An image reading position decision circuit stores setting information in regard to whether to read the image from a flash memory or to read from the image from the external hard disk drive in response to a playback instruction. When the setting information is set as ‘from hard disk drive’, a CPU in the camera orders to the computer to transmit the image into the camera and displays the received image on the LCD display panel in response to operation by a playback instruction switch and an image advance switch.

However, the prior art described in a Japanese Patent Laid-Open No. 2001-359044 gazette requires an operator to choose between either playback from the external computer or playback from an internal recording media via a complicated method.

To overcome these limitations, what is desired, as discovered by the present inventors, is a camera memory management capability that allows for easy retrieval and display and that will not delay or prevent image capture during the transfer of a previously captured image.

### BRIEF DESCRIPTION OF THE DRAWINGS

FIG. 1 is a block diagram that shows composition of the digital camera by a one embodiment of the present invention;

FIG. 2 is a flow chart that shows an operation of the first embodiment of the present invention;

FIG. 3 is a flow chart that shows an operation of the second embodiment of the present invention;

FIG. 4 is a flow chart that shows an operation of the third embodiment of the present invention; and

FIG. 5 is a flow chart that shows an operation of the forth embodiment of the present invention.

### SUMMARY OF THE INVENTION

It is an object of the present invention to provide a digital camera, as well as a corresponding method and computer program product that has an improved memory management capability and that does not need a large capacity information storing medium to drive a display but instead includes means of playing back on the digital camera after receiving the image files transmitted into an external device such as a personal computer, effectively. Alternatively, a large capacity internal memory may replace or supplement the external device.

The present invention provides a digital camera having an image pickup unit, a communication I/F, a display unit, a console and a control unit. The image pickup unit is configured to convert an optical image of a subject to an electric signal as image data comprising large-size image data and/or small-size image data. The large-size image data is a full-size image data and the small-size image data is a thumbnail-size image data corresponding to full-size image data, for instance. The communication I/F is configured to connect with an external information apparatus such as a personal computer for communicating the image data. The display unit is configured to display the image data. The console is configured to accept operation operated by user. The control unit having a temporary memory is configured to control the image pickup unit, the communication I/F, the display unit and the console. Also, the control unit stores the large-size image data and small-size image data corresponding to the large-size image data into the temporary memory independently after receiving from the external information apparatus, and orders to display the large-size image data and small-size image data corresponding to the large-size image on the display unit independently. The large-size image data is independently received from the external information apparatus to display an image including the large-size image data on the display unit after the small-size image data is received when the digital camera is in playback mode.

In one embodiment, the control unit receives the large-size image data corresponding to the small-size image data currently displayed on the display unit. In this case, it is also desirable that the control unit interrupts receipt of the large-size image data, and receives another small-size image data that should be displayed after processing of frame advance when the control unit receives a command for processing of frame advance operated by user during receiving the large-size image data.

In one embodiment, the control unit stores both a first image data and peripheral image data received from the external information apparatus. The peripheral image data includes either large-size image data and/or small-size image data that was transferred from the external information apparatus to the temporary memory either before or after the first image data was transferred. The first image data and the peripheral image data are arranged in a predetermined order. The control unit orders the display of the peripheral image data stored in the temporary memory upon receipt of a frame advance command from the user.

In one embodiment, the predetermined order for arranging the image data in said external information apparatus is file name order or shot order.

In one embodiment, the control unit determines whether the small-size image data, except both the image data displayed currently and the peripheral image data, exists in the temporary memory. The control unit receives the peripheral small-size image data not stored in the temporary memory from the external information apparatus in order to store the peripheral small-size image data into temporary memory after deleting unwanted small-size image based on determining that said unwanted small-size image data exists in temporary memory. And the control unit repeats the determining, deleting, receiving and storing process until a predetermined number of the peripheral small-size image data is received.

In one embodiment, the control unit determines whether the large-size image data, except both the image data displayed currently and the peripheral image data, exists in the temporary memory. The control unit receives the peripheral large-size image data not stored in the temporary memory from the external information apparatus in order to store the peripheral large-size image data into temporary memory after deleting unwanted large-size image based on the determining when unwanted said large-size image data exists in said temporary memory. And the control unit repeats the determining, deleting, receiving and storing process until a predetermined number of the peripheral large-size image data is received.

In one embodiment, the control unit generates directory configured to store the image data according to a shooting theme, and switches the directory for storing the image data according to an operation by user with said console.

In one embodiment the control unit receives, uses and displays an indication of the number of image files that are stored in the external information apparatus. This information may be received from the external information apparatus before receiving the image data.

With this improved temporary memory management capability, the digital camera of the present invention can display archived images more efficiently and can more quickly switch between display and image capture modes.

### DETAILED DESCRIPTION OF THE PREFERED EMBODYMENT

Referring to the accompanying drawings, a description is made of detailed description of the preferred embodiment of the present invention. The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

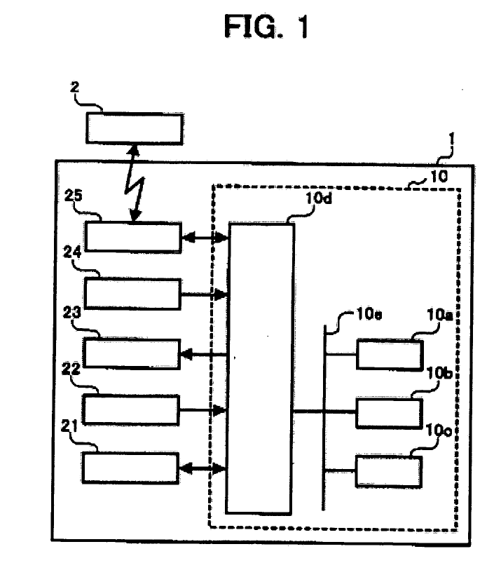

FIG. 1 is a block diagram that shows a composition of a digital camera according to one embodiment of the present invention. The digital camera 1 can communicate with an external information apparatus such as personal computer 2 through a communications link such as an USB cable, Bluetooth or so on. The digital camera 1 comprises a storage unit 21, an image pickup unit 22, a display unit 23, a console 24, a PC I/F unit 25 and a control unit 10. The storage unit 21 is configured to store camera operating information into a memory such as a flash memory. The image pickup unit 22 is configured to convert an optical image of a subject to an electric signal and includes a CCD and AD converter. The display unit 23 is configured to display various types of information such as image data, shooting information and playback information. The console 24 is configured to enable the input of operating information by a user from outside of the digital camera. The PC I/F unit 25 is an interface configured to be connected to the personal computer 2. The control unit 10 is configured to control the digital camera generally and comprises a common microcomputer such as one that includes a CPU 10a, a ROM 10b, a RAM 10c an I/O port 10d and a bus line 10e for connecting with the above-mentioned components. The ROM 10b is employed as temporary memory for storing image data and so on, for instance.

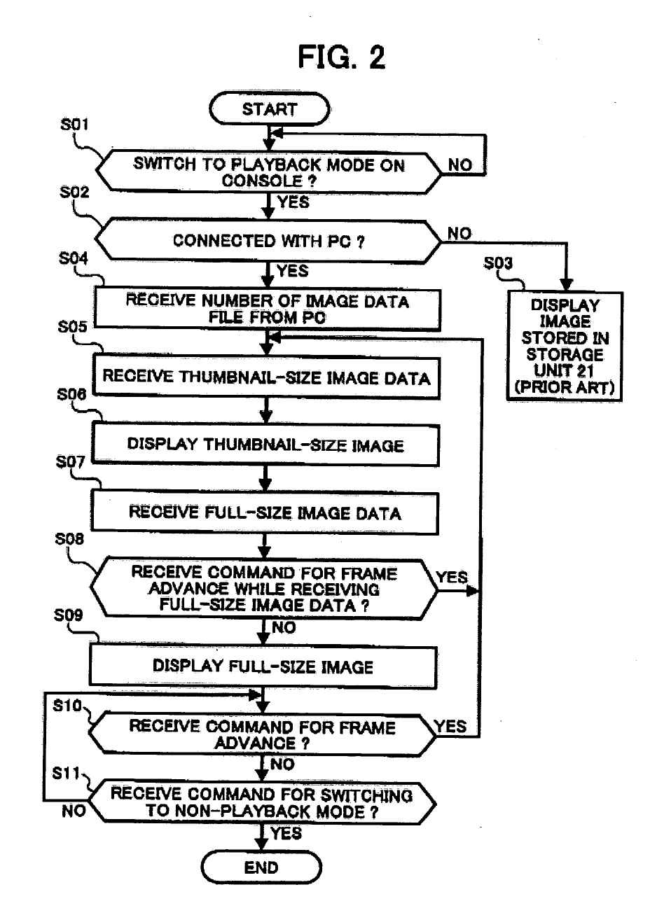

FIG. 2 is a flow chart that shows an operation of the first embodiment of the present invention. When a switching operation into playback mode is ordered by the user (step SOI) with the console 24, the control unit 10 determines whether the digital camera is connected with the personal computer 2 thru the PC I/F unit 25 (step S02). If THE result of the above-mentioned determining is ‘unconnected’ (route ‘No’ on step S02), the control unit 10 orders the display on the display unit 23 (step S03) of image data included in an image file stored in the storage unit 21. In this case, explanation after step S03 is omitted because processing of hereafter is same as playback process of well-known digital camera.

If result of the above-mentioned determining is ‘connected’ (route ‘Yes’ on S02), the control unit 10 receives indication of the number of image files that are stored in the personal computer 2 (S04). The number of a specific image file and the total number of stored image files is displayed on the display unit 23.

Then thumbnail-size image data corresponding to large-size image data is received (step S05). After receiving the thumbnail-size image data, the control unit 10 orders the display of thumbnail-size image included in the thumbnail-size image data on the display unit 23 (step S06). In addition, when the control unit 10 receives an instruction for a frame advance (step not shown) by the user with the console 24, the control unit 10 immediately orders a frame advance even if the camera is processing on steps S05 or S06. In this case, the camera goes back to step S05 again.

After displaying the thumbnail-size image or at the same time as displaying the thumbnail-size image, the control unit 10 receives full-size image data corresponding to the received thumbnail-size images data (step S07). It should be started to receive the full-size image data at the same time as displaying the thumbnail-size image mentioned in S06 because of effective use of telecommunication line. When the control unit 10 receives an instruction for a frame advance from the user via console 24 during receiving the full-size image data (step S08), the control unit 10 interrupts the receipt of the full-size image data, and orders to process frame advance right now and next step goes back to S05 again (step S08).

After receiving the full-size image data, the control unit 10 orders the display of the full-size image on the display unit 23 (step S09). When the control unit 10 receives an instruction for a frame advance from the user via the console 24 (step S10), the camera returns to step S05 again. When the control unit 10 receives a command to switch to a non-playback mode from the user via the console 24 (step S11), processing of the present embodiment is done.

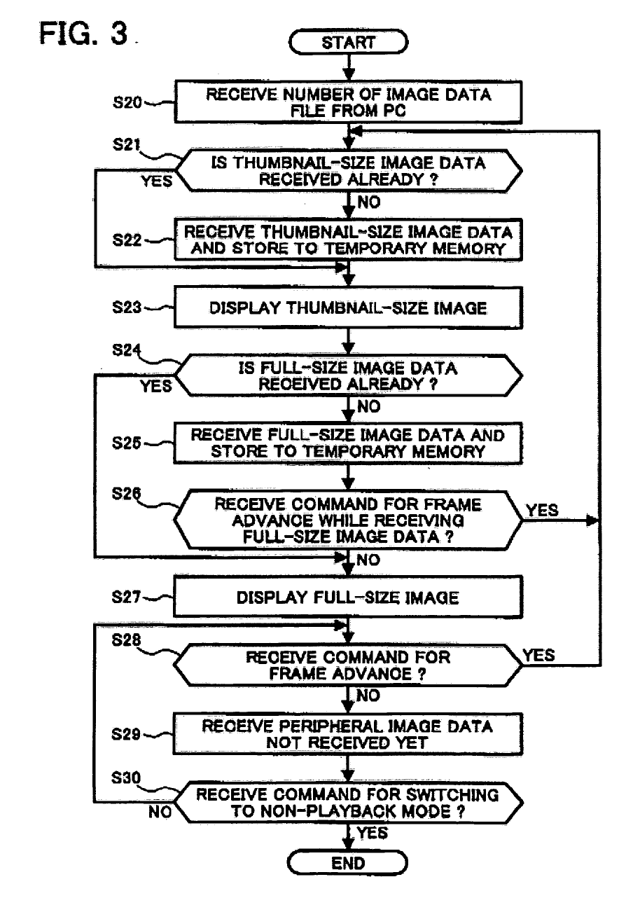

FIG. 3 is a flow chart that shows an operation of the second embodiment of the present invention. Concretely, this flow chart identifies steps that may occur after step S04 o in FIG. 1. If the digital camera 1 is connected with the personal computer 2, the control unit 10 receives the number of the image files stored in the personal computer 2 (step S20). The control unit 10 determines whether the thumbnail-size image data is stored in a temporary memory arranged in the digital camera (step S21). If the thumbnail-size image data is stored (route ‘Yes’ on step S21), the following receiving process (step S22) will be skipped (step S21). If the thumbnail-size image data is not stored (route ‘No’ on step S21), the control unit 10 receives the thumbnail-size image data from the personal computer 2 and stores said data into the temporary memory (step S22). The temporary memory is such as the RAM 10c or the storage unit 21. And then the control unit 10 orders the display of the thumbnail-size image on the display unit 23 (step S23).

The control unit 10 determines whether the full-size image data corresponding to the thumbnail-size image data displayed currently is stored in the temporary memory (step S24). If the full-size image data corresponding to the thumbnail-size image data displayed currently is stored (route ‘Yes’ on step S24), the following receiving process (step S25) will be skipped. If the full-size image data corresponding to the thumbnail-size image data displayed currently is not stored (route ‘No’ on step S24), the control unit 10 receives the full-size image data corresponding to the thumbnail-size image data displayed currently and stores into the temporary memory (step S25). If the control unit 10 receives a frame advance command from the user via the console 24 while receiving the full-size image data (step S26), the control unit 10 immediately orders the frame advance and to the process returns to step S21. After receiving the full-size image data corresponding to the thumbnail-size image data displayed currently, the control unit 10 orders to display the full-size image received just before on the display unit 23 (step S27).

When the control unit 10 receives the for of frame advance processing command from the user via the console 24 (step S28), the process returns to step S21 again.

While a full-size image is displayed for confirmation by the user, the control unit 10 receives ‘the image data at periphery’ included in ‘the image files at periphery’ not received yet from the personal computer 2, and stores the peripheral image data into the temporary memory (step S29). In other words, peripheral image data is large-size and/or small size image data that was transferred from the external device to the temporary memory either before or after the image being displayed was transferred. Also, ‘the image files at periphery’ include more than two image files configured to a pair that are before and after the image file having the image data corresponding to the image displayed on the display unit 23 currently. Namely, the number of ‘the image files at periphery’ is set more than two in advance, and will be decided based on capacity of the temporary memory.

According to circumstances, deleting some image data from the temporary memory that is used to drive the display is desirable during the above processing because of capacity of the temporary memory. (Note that deleting images from the temporary memory may or may not result in deleting images from the permanent memory.) Deleting unwanted image data from the temporary memory except both ‘the image data displayed currently’ and ‘the image data at periphery’ is desirable, for instance. By this deletion process, the digital camera 1 gets advantage that the temporary memory having less capacity is sufficient.

Finally, when the control unit 10 receives the command for switching to non-playback mode operated by the user with the console 24, processing of the present embodiment is done (step S30).

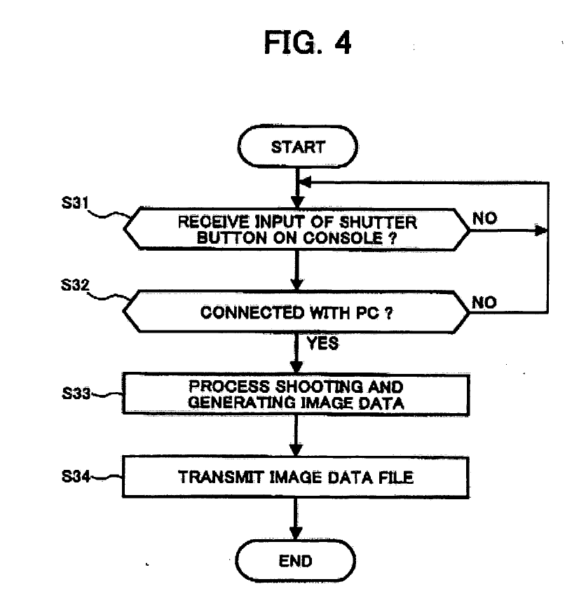

FIG. 4 is a flow chart that shows an operation of the third embodiment of the present invention. The control unit 10 determines whether the digital camera is connected with the personal computer 2 thru the PC I/F unit 25 (step S32) after receiving an input from a shutter button for shutter release from the user via the console (step S31). If result of the above-mentioned determining is ‘unconnected’ (route ‘No’ on step S32), the control unit 10 orders the display of messages, such as an error message, and waits until receiving input of shutter button again. If the result of the above-mentioned determining is ‘connected’ (route ‘Yes’ on step S32), the control unit 10 orders the shooting of a picture and the generating of an image data file corresponding to the picture after shooting (step S33).

After generating the image data file, the control unit 10 orders the transmission of the image data file into the personal computer 2 (step S34). Here, the input of a shutter button signaling shutter release causes the shutter to operate before the transmission of the image data file is completed. In this case, the response speed after receiving input is improved by means of multitask operation such as processing another task for transmitting the image data file.

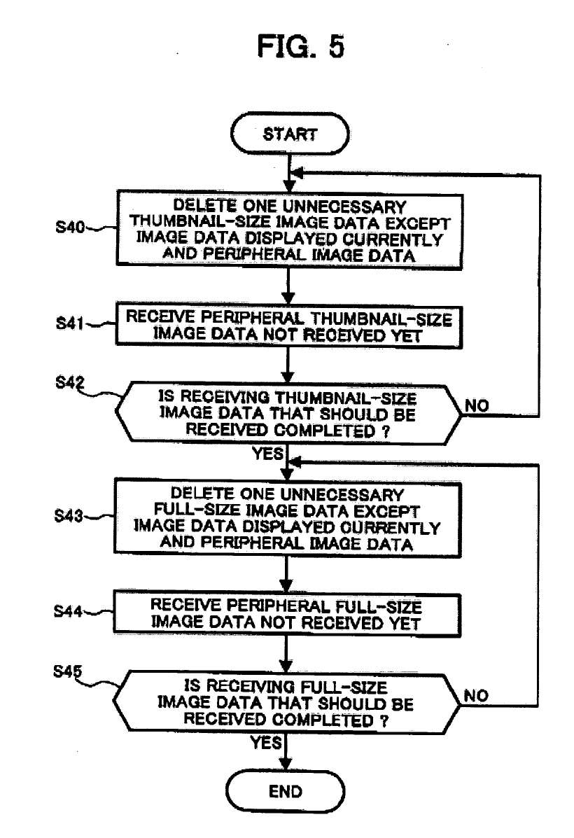

FIG. 5 is a flow chart that shows an operation of the fourth embodiment of the present invention. FIG. 5 can replace step S29 of FIG. 3. That is, the ‘Start’ and ‘End’ steps on FIG. 5 join to step S28 and step S30 on FIG. 3 respectively.

In this embodiment, the control unit 10 determines whether unwanted thumbnail-size image data stored in the temporary memory temporarily (i.e., all files except those identified as ‘the image data displayed currently’ and ‘the thumbnail-size image data at periphery’). When the unwanted thumbnail-size image data is detected in the temporary memory, the control unit 10 deletes the unwanted thumbnail-size image data (step S40). This process is desirable for controlling amount of whole image data that should be stored does not exceed capacity of the temporary memory.

After the deleting process of step S40, the control unit 10 detects ‘the thumbnail-size image data at periphery’ that has not yet been received and should be received, receives from the personal computer 2 and stores into the temporary memory (step S41).

Then, the control unit 10 determines whether a predetermined number of the thumbnail-size image data at periphery that should be received was completely received (step S42). If all the periphery data is not received (route ‘No’ on step S42), the process goes back to step S40 again. The process between step S40 and step S42 are repeated until completed. After completed (route ‘Yes’ on step S42), the control unit 10 determines if unwanted full-size image data is stored in the temporary memory temporarily except both ‘the full-size image data displayed currently’ and ‘the image data at periphery’ (step not shown). When the unwanted full-size image data exists in the temporary memory, the control unit 10 deletes the unwanted full-size image data (step S43).

After above-mentioned deleting of step S43, the control unit 10 detects ‘full-size image data at periphery’ that is not received yet and should be received, receives from the personal computer 2, and stores this data into the temporary memory (step S44). Then, the control unit 10 determines whether predetermined number of ‘the full-size image data at periphery’ that should be received was completely received (step S45). If not completed yet (route ‘No’ on step S45), the process goes back to step S43 again. The process between step S43 and step S45 will is repeated until completed.

When the control unit 10 receives a frame advance processing command from the user via the console 24 during the above-mentioned processing of the fourth embodiment of the present invention (step not shown), the control unit 10 may either order the frame advance or interrupt the above-mentioned operation. The selection of a next step of either the frame advance or interrupting the above-mentioned operation will be decided based on a specification of the digital camera 1 such as capacity of the temporary memory or operability.

In other words, in one embodiment the temporary memory is sized to hold 5 images, the image being displayed and two prior (e.g., previously viewed) images and two subsequent (e.g., to be viewed) images. When the frame advance command is given, the oldest prior image is deleted, the displayed image becomes a prior image, the next image is displayed, and a new image is loaded into the temporary memory as a subsequent image. This process continues for each frame advance until all images are cycled through the temporary memory. When a frame advance command is received after the last image is uploaded into the temporary memory, the cycle repeats with the first image in the external memory becoming a subsequent image.

Throughout this process, the image number data is transferred and, when appropriate, displayed. Thus, in one example where the temporary memory is sized for 5 images and the external memory holds 30 actual images, the displayed image is accompanied by an indication (e.g., if the displayed image is the fifth image, the display also shows 5/30). When the 28^{th} image is displayed, the prior peripheral data in the temporary memory includes images 26 and 27 and the subsequent peripheral data includes images 29 and 30. When a frame advance command is received, the 26^{th} image is purged, the prior peripheral images become 27 and 28, the displayed image is 29, and the subsequent images are 30 and 1. The process also works in reverse when a reverse frame advance command is received.

Also, if the digital camera 1 furthermore includes both a) a directory generating means to generate a directory for storing the image file into the personal computer 2 and b) a directory switching means to switch the directory for storing other image file, the user can handle many image files easily by means of switching the directory for storing the image files in order to be organized in the directories according to a shooting theme.

The preceding discussion about the interaction between the temporary memory that drives the display and the memory in the external device was described. However, similar interactions between the temporary memory and an embedded and/or removable non-volatile memory associated with the camera as also possible.

Numerous variations on the above-disclosed inventions are possible to one skilled in the art and are considered within scope of the disclosed invention.

1. A digital camera, comprising:
an image pickup unit configured to convert an optical image of a subject to an electric signal as image data;
a communication I/F configured to connect with an external information apparatus and to communicate said image data to said external information apparatus;
a display unit configured to display said image data;
a console configured to receive a user command; and
a control unit having a temporary memory and configured to control said image pickup unit, said communication I/F, said display unit and said console,
wherein said image data comprises a large-size image data and a small-size image data corresponding to said large-size image data, and
said control unit is configured to receive and store into said temporary memory said large-size image data and said corresponding small-size image data independently.

2. The digital camera of claim 1, wherein:
said control unit is configured to receive said large-size image data while said small-size image data is displayed on said display unit.

3. The digital camera of claim 2, wherein:
said control unit is configured to interrupt receipt of said large-size image data, and to receive and display another small-size image data in response to receipt of a frame advance command.

4. The digital camera of claim 1, wherein:
said control unit is configured to store peripheral image data into said temporary memory, said peripheral image data being a predetermined amount of image data that was transferred before or after the transfer of an image currently displayed on said display unit.

5. The digital camera of claim 4, said peripheral image data comprising:
one of a peripheral large-size image data and a peripheral small-size image data.

6. The digital camera of claim 5, wherein said currently displayed image data and said peripheral image data are stored in said external information apparatus in a predetermined order.

7. The digital camera of claim 6, wherein said control unit is configured to order a display of said peripheral image data in response to a frame advance command.

8. The digital camera of claim 6, wherein:
said predetermined order is file name order.

9. The digital camera of claim 6, wherein:
said predetermined order is shot order.

10. The digital camera of claim 4, wherein:
said control unit is configured to detect and delete unwanted image data in said temporary memory, said unwanted image data being any small-size image data other than said currently displayed image data and said peripheral image data; and
said control unit is configured to receive and store additional peripheral small-size image data after deleting said unwanted small-size image from said temporary memory.

11. The digital camera of claim 10, wherein
said control unit is configured to repeatedly detect and delete unwanted small-size image data and receive and store additional peripheral small-size image data until a predetermined amount of additional peripheral small-size image data is transferred.

12. The digital camera of claim 4, wherein:
said control unit is configured to detect and delete unwanted large-size image data in said temporary memory, said unwanted image data being any large-size image data other than said currently displayed image data and said peripheral image data; and
said control unit is configured to receive and store said additional peripheral large-size image data after deleting said unwanted large-size image from said temporary memory.

13. The digital camera of claim 12, wherein
said control unit is configured to repeatedly detect and delete unwanted large-size image data and receive and store additional peripheral large-size image data until a predetermined amount of additional peripheral large-size image data is transferred.

14. The digital camera of claim 1, wherein:
said control unit is configured to generate a directory configured to store said image data according to a shooting theme.

15. The digital camera of claim 14, wherein
said control unit is configured to switch said directory to another directory in response to a user command.

16. The digital camera of claim 1, wherein:
said control unit is configured to receive an indication of a number of image files being stored in said external information apparatus before receiving said image data.

17. A method of controlling a digital camera connectable to an external information apparatus for communicating an image data, comprising the steps of:
converting in said digital camera an optical image into image data comprising one of small-size image data and corresponding large-size image data;
storing said image data into an external information apparatus connected to said digital camera via a communication I/F;
transferring both said small-size image data and said large-size image data corresponding to said small-size image data independently to said digital camera from said external information apparatus;
storing both said small-size image data and said large-size image data corresponding to said small-size image data independently into a temporary memory housed in said digital camera; and
displaying said small-size image data and said large-size image data corresponding to said small-size image data on a display unit arranged in said digital camera, independently.

18. The method of claim 17, further comprising the step of:
receiving a frame advance command while receiving said large-size image data:
interrupting the receipt of said large-size image data; and
receiving another small-size image data.

19. The method of claim 17, further comprising the step of:
storing peripheral image data in said temporary memory, said peripheral image data being a predetermined amount of image data that was transferred from said external information apparatus before or after the transfer of an image currently displayed and comprising one of peripheral large-size image data and peripheral small-size image data;
arranging said peripheral image data and image data in a predetermined order, and
displaying said peripheral image data stored in said temporary memory in response to a frame advance command.

20. The method of claim 19, wherein:
said predetermined order is file name order.

21. The method of claim 19, wherein:
said predetermined order is shot order.

22. The method of claim 21, further comprising the step of:
detecting and deleting unwanted image data in said temporary memory, said unwanted image data being any small-size image data other than said currently displayed image data and said peripheral image data; and
receiving and storing additional peripheral small-size image data into said temporary memory after deleting said unwanted small-size image from said temporary memory.

23. The method of claim 22, further comprising:
repeatedly detecting and deleting unwanted small-size image data and receiving and storing additional peripheral small-size image data until a predetermined amount of additional peripheral small-size image data is transferred.

24. The method of claim 19, further comprising:
detecting and deleting unwanted large-size image data in said temporary memory, said unwanted image data being any large-size image data other than said currently displayed image data and said peripheral image data; and
receiving and storing said additional peripheral large-size image data after deleting said unwanted large-size image from said temporary memory.

25. The method of claim 24, further comprising:
repeatedly detecting and deleting unwanted large-size image data and receiving and storing additional peripheral large-size image data until a predetermined amount of additional peripheral large-size image data is transferred.

26. The method of claim 17, further comprising the steps of:
generating a directory configured to store said image data according to a shooting theme; and
switching said directory to another director in response to a user command.

27. The method of claim 17, further comprising the step of:
receiving an indication of a total number of image file stored in said external information apparatus before receiving said image data.

28. A digital camera, comprising:
means for converting in said digital camera an optical image into image data comprising one of small-size image data and corresponding large-size image data;
means for storing said image data into an external information apparatus connected to said digital camera via a communication I/F;
means for transferring both said small-size image data and said large-size image data corresponding to said small-size image data independently to said digital camera from said external information apparatus;
means for storing both said small-size image data and said large-size image data corresponding to said small-size image data independently into a temporary memory housed in said digital camera; and
means for displaying said small-size image data and said large-size image data corresponding to said small-size image data on a display unit arranged in said digital camera, independently.

29. The digital camera of claim 28, further comprising:
means for receiving a frame advance command while receiving said large-size image data:
means for interrupting the receipt of said large-size image data; and
means for receiving another small-size image data.

30. The digital camera of claim 28, further comprising:
means for storing peripheral image data in said temporary memory, said peripheral image data being a predetermined amount of image data that was transferred from said external information apparatus before or after the transfer of an image currently displayed and comprising one of peripheral large-size image data and peripheral small-size image data;
means for arranging said peripheral image data and image data in a predetermined order, and
means for displaying said peripheral image data stored in said temporary memory in response to a frame advance command.

31. The digital camera of claim 30, wherein:
said predetermined order is file name order.

32. The digital camera of claim 30, wherein:
said predetermined order is shot order.

33. The digital camera of claim 28, further comprising:
means for detecting and deleting unwanted image data in said temporary memory, said unwanted image data being any small-size image data other than said currently displayed image data and said peripheral image data; and
means for receiving and storing additional peripheral small-size image data into said temporary memory after deleting said unwanted small-size image from said temporary memory.

34. The digital camera of claim 33, further comprising:
means for repeatedly detecting and deleting unwanted small-size image data and receiving and storing additional peripheral small-size image data until a predetermined amount of additional peripheral small-size image data is transferred.

35. The digital camera of claim 28, further comprising:
means for detecting and deleting unwanted large-size image data in said temporary memory, said unwanted image data being any large-size image data other than said currently displayed image data and said peripheral image data; and
means for receiving and storing said additional peripheral large-size image data after deleting said unwanted large-size image from said temporary memory.

36. The digital camera of claim 35, further comprising:
means for repeatedly detecting and deleting unwanted large-size image data and receiving and storing additional peripheral large-size image data until a predetermined amount of additional peripheral large-size image data is transferred.

37. The digital camera of claim 28, further comprising:
means for generating a directory configured to store said image data according to a shooting theme; and
means for switching said directory to another director in response to a user command.

38. The digital camera of claim 28, further comprising:
receiving means for receiving an indication of a number of image file stored in said external information apparatus.

39. A computer program product comprising instructions for controlling a digital camera connectable to an external information apparatus according to the method recited in one of claims 17-27.
